(19) United States
(12) Patent Application Publication
(10) Pub. No.: US 2006/0053452 A1
(43) Pub. Date: Mar. 9, 2006

(54) Wired/wireless broadcasting distribution apparatus having a home broadcasting distribution function and broadcasting channel formation/termination method using the same

(76) Inventors: Sangjae Lee, Daejeon-city (KR); Youn Kwae Jeong, Daejeon-city (KR); Kwang Roh Park, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/985,105

(22) Filed: Nov. 9, 2004

(30) Foreign Application Priority Data
Sep. 8, 2004 (KR) 2004-71625

(51) Int. Cl. H04N 7/18

(52) U.S. Cl. 725/81; 725/80; 725/74

(57) ABSTRACT

The present invention relates to a wired/wireless broadcasting distribution apparatus having a home broadcasting distribution function and a broadcasting channel formation/termination method using the same. A wired/wireless broadcasting distribution apparatus according the present invention receives HD-grade multi-channel ground wave/satellite/cable broadcasting signals, and converts the received broadcasting signals into an IEEE1394 Isochronous packet or converts the IEEE1394 Isochronous packet into a UWB wireless signal, and transmits the IEEE1394 Isochronous packet or the UWB wireless signal to a home client, thereby making it possible to distribute HD-grade multi-channel wired/wireless broadcasting signals requiring a transmission bandwidth of hundreds Mbps to home clients irrespective of place.

### BACKGROUND OF THE INVENITON

1 Field of the Invention

The present invention relates to a wired/wireless broadcasting distribution apparatus and method for home broadcasting distribution, and more particularly, to a method for receiving a plurality of HD-grade digital broadcasting signals and converting the HD-grade digital broadcasting signals into IEEE1394 and ultra wideband (UWB) signals and distributing the IEEE1394 and UWB signals to a plurality of broadcasting reception clients located in a home.

2. Description of the Related Art

In general, for broadcasting reception in a home, broadcasting signals transmitted from a ground wave broadcasting station, a satellite antenna or a cable service provider are distributed into a home through a coaxial cable and are then received and viewed through a set-top box or a television (TV).

However, an outlet to which a coaxial cable can be connected is fixed to a wall in a home or should be separately installed.

Moreover, since a TV is recently viewed through various devices such as a personal computer (PC) and a mobile device, it is difficult to construct a broadcasting distribution network in a home.

Since a method of transmitting broadcasting data through an IP packet has been recently developed, broadcasting data can be transmitted through a data line such as UTP, not a coaxial cable. However, this method also uses a wired line and therefore cannot provide movability and requires a wired line to be separately installed in case of an existing house. Moreover, there is a problem that a home back bone network having a bandwidth of hundreds Mbps or more, such as an IEEE1394 network and a UWB network, is needed in order to transmits HD-grade multi-channel broadcasting signals.

### SUMMARY OF THE INVENTION

Accordingly, the present invention is directed to a wired/wireless broadcasting distribution apparatus having a home broadcasting distribution function and a broadcasting channel formation/termination method using the same, which receives HD-grade multi-channel broadcasting signals, converts the broadcasting signals into MPEG TS data by using tuners for receiving ground wave/satellite/cable broadcasting signals and converts the MPEG TS data into an IEEE1394 packet prior to wired transmission or converts the IEEE1394 packet into a UWB packet prior to wireless transmission, thereby making it possible to distribute the broadcasting signals to home clients, through a wired cable or a wireless channel, irrespective of place.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a wired/wireless broadcasting distribution apparatus having a home broadcasting distribution function. The apparatus includes: a digital broadcasting receiver for selectively receiving HD-grade ground wave/satellite/cable broadcasting signals; a signal converter for converting MPEG TS (Transport Stream) broadcasting data received from the digital broadcasting receiver into an IEEE1394 Isochronous packet; a wireless transceiver 130 for matching the IEEE1394 Isochronous packet received from the signal converter and converting the IEEE1394 Isochronous packet into a UWB wireless signal and transmitting the UWB wireless signal to a home wireless network; and a controller 140 for controlling the digital broadcasting receivers, the signal converter and the wireless transceiver and managing a status of a channel which is being received.

In another aspect of the present invention, there is provided a method for generating a broadcasting channel by a wired/wireless broadcasting distribution apparatus having a home broadcasting distribution function. The method includes the steps of: (a) if a broadcasting channel reception request signal is received from a home broadcasting reception client, determining whether a broadcasting channel reception request signal is received through a wired IEEE1394 network or through a UWB wireless channel; (b) if the broadcasting channel reception request signal is received through a wired IEEE1394 network, transmitting a IEEE1394 ID and broadcasting channel information to a signal converter; (c) after determining at the signal converter whether an additional bandwidth can be currently assigned to the wired IEEE1394 network, if an addition bandwidth can be currently assigned to the wired IEEE1394 network, transmitting a reception channel list update request message to a channel status management unit; (d) upon receiving the reception channel list update request message at the channel status management unit, determining whether a currently received channel is a new channel, (e) if the currently received channel is a new channel, registering new channel information in a reception channel list, activating a TS input port of a signal conversion management unit 142 and transmitting a IEEE1394 ID of a reception request client to a 1394 ISO data generator; (f) selecting a reception tuner at a broadcasting reception management unit according to broadcasting channel information requested by the client and then receiving a broadcasting signal by controlling the selected tuner; and (g) converting at the signal converter MPEG TS broadcasting data received from the digital broadcasting receiver into a IEEE1394 Isochronous packet, and according to types of the client requesting reception of a broadcasting channel, transmitting the IEEE1394 Isochronous packet to the wired 1394 network or converting the IEEE1394 Isochronous packet into a UWB packet and then transmitting the UWB packet to the home.

In further another aspect of the present invention, there is provided a method for terminating a broadcasting channel by a wired/wireless broadcasting distribution apparatus having a home broadcasting distribution function. The method includes the steps of: (p) if a broadcasting channel termination request signal is received from a home broadcasting reception client and if the channel requested to be terminated corresponds to a wired 1394 network, transmitting the broadcasting channel termination request signal to a signal converter, and if the channel requested to be terminated corresponds to a UWB wireless network, transmitting the broadcasting channel termination request signal through the wireless transceiver to the signal converter 110; (q) if the signal converter transmits the broadcasting channel termination request signal to a channel status management unit, searching a reception channel list at the channel status management unit and then determining whether a channel requested to be terminated is being transmitted to another client; (r) if the channel requested to be terminated is not being transmitted to another client, deleting the channel from a reception channel list at the channel status management unit and then requesting a signal conversion management unit to deactivate its TS input port and simultaneously transmitting, to a broadcasting reception management unit, information on a tuner which is receiving a channel which is to be terminated; and (s) deactivating a corresponding tuner by controlling the digital broadcasting receiver at the broadcasting reception management unit and deleting a IEEE1394 ID or a UWB channel of a client having requested termination of a channel.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention, are incorporated in and constitute a part of this application, illustrate embodiments of the invention and together with the description serve to explain the principle of the invention. In the drawings:

FIG. 1 is a diagram illustrating a structure of a home broadcasting distribution network adopting a wired/wireless broadcasting distribution apparatus according to an embodiment of the present invention;

FIG. 2 is a detailed block diagram of a wired/wireless broadcasting distribution apparatus according to an embodiment of the present invention;

FIG. 3 is a diagram illustrating a method of converting broadcasting data into an IEEE1394 packet or a UWB packet according to an embodiment of the present invention;

FIG. 4 is a flow diagram illustrating a method for generating a broadcasting channel by using the wired/wireless broadcasting distribution apparatus according to an embodiment of the present invention; and

FIG. 5 is a flow diagram illustrating a method for terminating a broadcasting channel by using the wired/wireless broadcasting distribution apparatus according-to an embodiment of the present invention.

### DETAILED DESCRIPTION OF THE INVENTION

Reference will now be made in detail to the preferred embodiments of the present invention, examples of which are illustrated in the accompanying drawings.

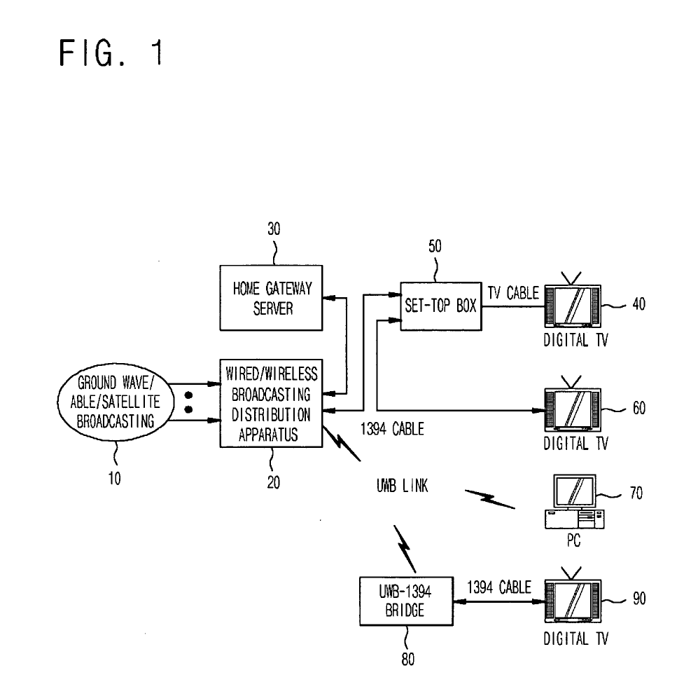

FIG. 1 is a diagram illustrating a structure of a home broadcasting distribution network adopting a wired/wireless broadcasting distribution apparatus according to an embodiment of the present invention.

Referring to FIG. 1, the home broadcasting distribution network includes a wired/wireless broadcasting distribution apparatus 20 for receiving HD multi-channel ground wave/satellite/cable broadcasting data 10 and distributing the received data into a home, a home gateway server 30 for recording the received broadcasting data like a personal video recorder (PVR), a set-top box 50 for MPEG-decoding the broadcasting data transmitted from the wired/wireless broadcasting distribution apparatus 20 through an IEEE1394 cable and then transmitting the decoded broadcasting data to a general digital TV 40 or recording the broadcasting data, a digital TV 60 having the MPEG decoding function and directly matched with the IEEE1394 cable, a PC 70 having a UWB wireless matching function, and a UWB-1394 bridge 80 for converting a UWB packet into an IEEE1394 packet.

The wired/wireless broadcasting distribution apparatus 20 distributes the ground wave/satellite/cable broadcasting data received into a home, by IEEE1394 cable and by wireless UWB, according to channel reception request information from a home broadcasting reception client. The distributed broadcasting data is transmitted to and stored in the home gateway server 30 and the set-top box 50 or is redistributed into the home through a wired/wireless distribution network according to user's selection.

The set-top box 50 matches the IEEE1394 cable with an existing digital TV and an analog TV that do not have an MPEG-decoding function. The PC 70 having a UWB wireless matching function directly receives UWB-converted broadcasting data. Also, for wireless reception of broadcasting data by a digital TV, the small-sized UWB-1394 bridge 80 converts broadcasting data transmitted by wireless UWB into an IEEE1394 packet and transmits the IEEE1394 packet through an IEEE1394 cable to a digital TV 90 having an IEEE1394 matching function.

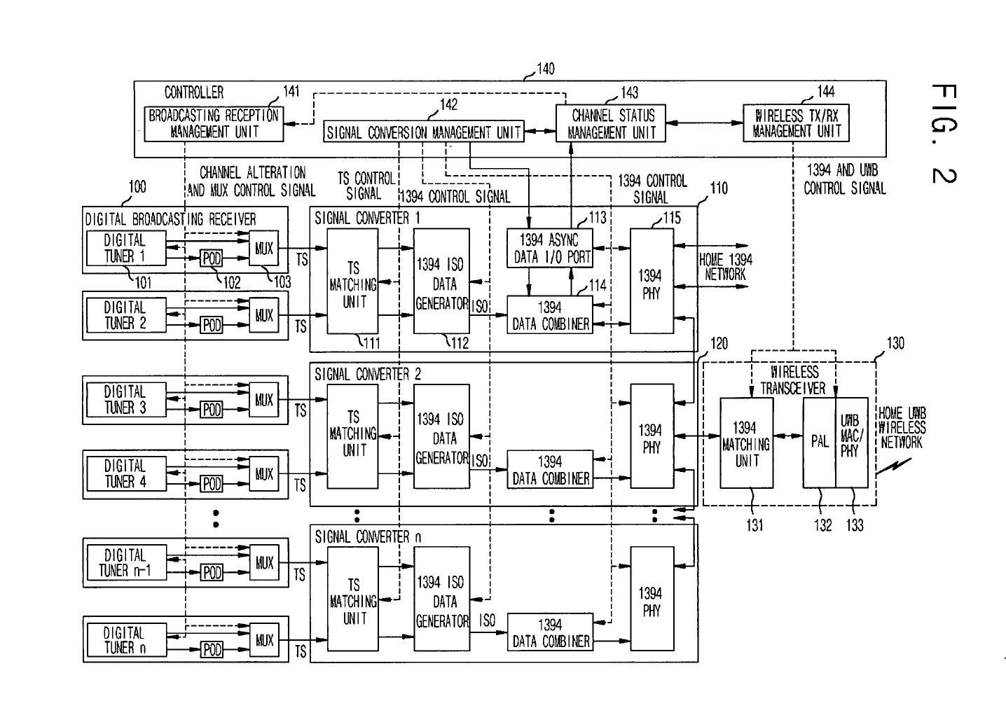

FIG. 2 is a detailed block diagram of a wired/wireless broadcasting distribution apparatus according to an embodiment of the present invention.

Referring to FIG. 2, the wired/wireless broadcasting distribution apparatus includes a plurality of digital broadcasting receivers 100 connected to a plurality of ground wave/satellite antennas and cable networks and selectively receiving broadcasting data, a signal converter 110 for converting SD/HD grade broadcasting data (MPEG TS (Transport Stream)) received by the digital broadcasting receivers into an IEEE1394 Isochronous packet, a wireless transceiver 130 for matching a signal transmitted from the signal converter 110 and converting the signal into a UWB wireless signal, and a controller 140 for controlling operations of the digital broadcasting receivers 100 and the signal converter 110 and the wireless transceiver 130 and managing a channel status.

The digital broadcasting receiver 100 includes a digital tuner 101 selectively attachable/detachable according to types of broadcasting, a POD (Point of Deployment) unit 102 for restoring cryptographed broadcasting data transmitted from satellite and cable broadcasting stations, and an MUX (Multiplexer) 103 for selecting non-cryptographed broadcasting data such as ground wave broadcasting data.

Here, two digital broadcasting receivers 100 are matched with the signal converter 110. Among a plurality of signal converters, the signal converter 110 having a 1394 ASYNC data I/O port 113 is basically installed in the apparatus, and the remaining signal converters 120 can be attached/detached to the apparatus in module type.

MPEG broadcasting data received from the digital broadcasting receiver 101 passes through a TS matching unit 111 of the signal converter 110 and is then converted into an Isochronous packet by a 1394 ISO data generator 112.

In the above conversion process, channel data requested by a home broadcasting reception client and IEEE1394 data extracted from 1394 information are inserted into the Isochronous packet. The resulting Isochronous packet is combined with a asynchronous packet transmitted from the 1394 ASYNC data I/O port 113 by a data combiner 114 and is then transmitted through a 1394 PHY 115 to a home IEEE1394 network or the wireless transceiver 130.

If a broadcasting reception client desiring to receive a channel identical to a channel already received exists, then the 1394 ISO data generator 112 reproduces one MPEG TS packet into two 1394 Isochronous packets prior to transmission.

Also, for wireless distribution of broadcasting data, IEEE1394 packets generated in the signal converters are transmitted to a 1394 matching unit 131 of the wireless transceiver 130 and is then matched with a UWB MAC/PHY 133 through a PAL 132.

The IEEE1394 packet is converted into a UWB wireless packet by the UWB MAC/PHY 133 and is then transmitted to a home UWB wireless network.

Further, a channel alteration request signal received from a home wireless network or a home wired IEEE1394 network is transmitted to the signal converter 110 having the 1394 ASYNC data I/O port 113 and is then extracted by the 1394 ASYNC data I/O port 113 prior to being processed by the controller 140.

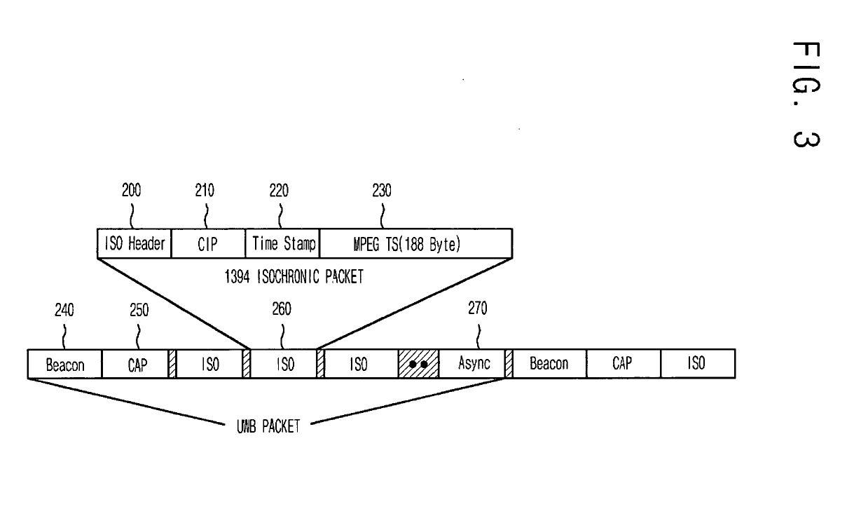

FIG. 3 is a diagram illustrating a method of converting broadcasting data into an IEEE1394 packet or a UWB packet according to an embodiment of the present invention.

Referring to FIGS. 2 and 3, the signal converter 110 converts MPEG TS data 230 received from the digital broadcasting receiver 100 into an IEEE1394 Isochronous packet by adding an ISO header, a CIP and a time stamp to the MPEG TS data 230, and then transmits the resulting IEEE1394 Isochronous packet to a home wired 1394 network.

For wireless transmission, the IEEE1394 Isochronous packet is again encapsulated into a UWB packet prior to transmission.

Here, a plurality of IEEE1394 Isochronous packets are assigned to a plurality of ISO transmission regions 260 in the UWB packet, and a beacon 240, a CAP 250 and an ASYNC packet 270 are also inserted into the UWB packet.

The ASYNC packet 270 includes channel-related control information requested by a home client and a notification message transmitted from the wired/wireless broadcasting distribution apparatus 20 to a home client, to which a 1394 ASYNC packet is mapped.

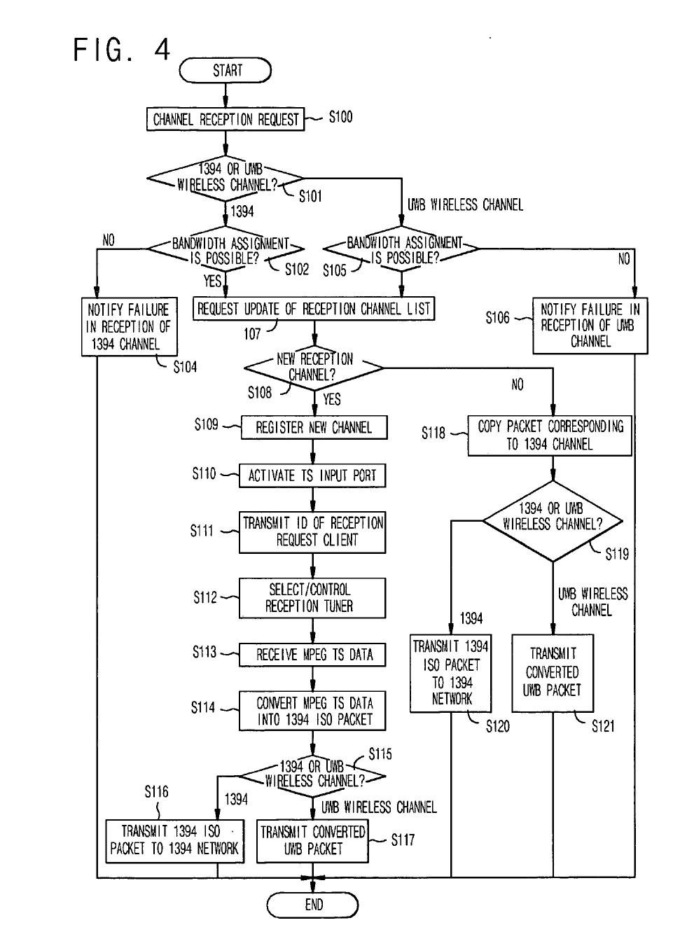

FIG. 4 is a flow diagram illustrating a method for generating a broadcasting channel by using the wired/wireless broadcasting distribution apparatus according to an embodiment of the present invention.

Referring to FIGS. 2 and 4, if the wired/wireless broadcasting distribution apparatus 20 receives a broadcasting channel reception request signal from a home broadcasting reception client (step S100), then the wired/wireless broadcasting distribution apparatus determines whether the broadcasting channel reception request signal is received through a wired 1394 network or through a UWB wireless channel (step

If the broadcasting channel reception request signal is received through a wired 1394 network, then the wired/wireless broadcasting distribution apparatus 20 transmits a IEEE1394 ID and broadcasting channel information to the signal converter 110.

The signal converter 110 determines whether an additional bandwidth can be currently assigned to the wired 1394 network (step S102). If an addition bandwidth can be currently assigned to the wired IEEE1394 network, then the signal converter 110 transmits a reception channel list update request message to a channel status management unit 143 in the controller 140 (step s107).

On the contrary, if an addition bandwidth cannot be currently assigned to the wired IEEE1394 network, then the wired/wireless broadcasting distribution apparatus 20 notifies the broadcasting reception client of a failure in reception of a IEEE1394 channel (step S104).

In the meanwhile, if the broadcasting channel reception request signal is received through a UWB wireless channel, then the wired/wireless broadcasting distribution apparatus 20 transmits a UWB ID and broadcasting channel information to the wireless transceiver 130.

The wireless transceiver 130 determines whether an additional bandwidth can be currently assigned to a wireless UWB network (step S105). If an addition bandwidth can be currently assigned to the wireless UWB network, then the wireless transceiver 130 transmits a reception channel list update request message to the channel status management unit 143 (step s107).

On the contrary, if an addition bandwidth cannot be currently assigned to the UWB wireless network, then the wired/wireless broadcasting distribution apparatus 20 notifies the broadcasting reception client of failure in reception of a UWB channel (step S106).

Upon receiving the reception channel list update request message, the channel status management unit 143 determines whether a currently received channel is a new channel (step S108).

If the currently received channel is a new channel, the channel status management unit 143 registers new channel information in a reception channel list, and then activates a TS input port of a signal conversion management unit 142 in the controller 140 (step S110).

The signal conversion management unit 142 transmits a 1394 ID of a reception request client to the 1394 ISO data generator 112 (step S111). A broadcasting reception management unit 141 of the controller 140 selects a reception tuner according to broadcasting channel information requested, and then receives a broadcasting signal by controlling the selected tuner (step S112).

Thereafter, the signal converter 110 receives MPEG TS broadcasting data from the digital broadcasting receiver 100 (step S113), and then converts the received MPEG TS broadcasting data into a IEEE1394 Isochronous packet (step S114). After that, if the broadcasting channel reception request signal was received through a wired IEEE1394 network, then the signal converter 110 transmits the IEEE1394 Isochronous packet to the wired IEEE1394 network (step S116).

On the contrary, if the broadcasting channel reception request signal was received through a UWB wireless channel, then the 1394 Isochronous packet is converted into a UWB wireless packet by the wireless transceiver and then the UWB wireless packet is transmitted to a home UWB wireless network (step S117).

In the meanwhile, if a currently received channel is determined to be not a new channel but a already serviced channel in step S108, then the channel status management unit 143 requests the signal conversion management unit 142, which is processing broadcasting data about a requested channel, to copy a packet corresponding to a IEEE1394 channel (step S118).

After that, the signal conversion management unit 142 transmits a channel copy command to the signal converter 110. If the broadcasting channel reception request signal was received through a wired IEEE1394 network, then the signal converter 110 copies broadcasting data and then transmits a copied IEEE1394 packet through a home wired IEEE1394 network to the client (step S120).

On the contrary, if the broadcasting channel reception request signal was received through a UWB 1394 wireless channel, then the copied IEEE1394 packet is converted into a UWB packet and the UWB packet is transmitted to a home UWB wireless network (step S121).

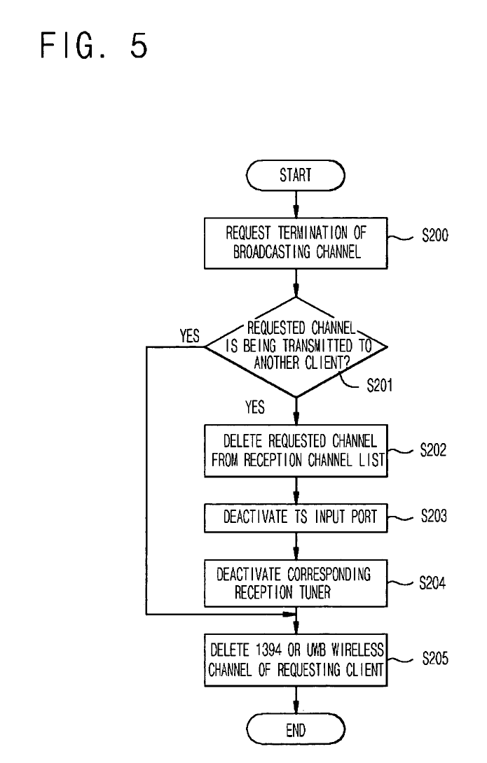

FIG. 5 is a flow diagram illustrating a method for terminating a broadcasting channel by using the wired/wireless broadcasting distribution apparatus according to an embodiment of the present invention.

Referring to FIGS. 2 and 5, if a broadcasting channel termination request signal is received from a home broadcasting reception client, and if the channel requested to be terminated corresponds to a wired IEEE1394 network, then the broadcasting channel termination request signal is transmitted to the signal converter 110. Otherwise, if the channel requested to be terminated corresponds to a UWB wireless network, the broadcasting channel termination request signal is transmitted through the wireless transceiver 130 to the signal converter 110 (step S200).

Thereafter, the signal converter 110 transmits the broadcasting channel termination request signal to the channel status management unit 143. Upon receiving the broadcasting channel termination request signal from the signal converter 110, the channel status management unit 143 searches a reception channel list and then determines whether a channel requested to be terminated is being transmitted to another client (step S201).

If a channel requested to be terminated is being transmitted to another client, the channel status management unit 143 requests the signal converter 110 to terminate a 1394 channel and then deletes a IEEE1394 ID of the client having requested termination of a channel, and requests the wireless transceiver 130 to terminate a UWB channel and then deletes a UWB wireless channel in case where the client having requested termination of a channel corresponds to a UWB wireless network (step S205).

On the contrary, if a channel requested to be terminated is not being transmitted to another client, the channel status management unit 143 deletes the channel from a reception channel list (step S202) and then requests the signal conversion management unit 142 to deactivate its TS input port (step S203) and simultaneously transmits information on a tuner which is receiving a channel which is to be terminated to the broadcasting reception management unit 141.

The broadcasting reception management unit 141 deactivates a corresponding tuner by controlling the digital broadcasting receiver 100 (step 204), requests the signal converter 110 to terminate a IEEE1394 channel and then deletes a IEEE1394 ID of the client having requested termination of a channel, and requests the wireless transceiver 130 to terminate a UWB channel and then deletes a UWB wireless channel in case where the client having requested termination of a channel corresponds to a UWB wireless network (step S205).

As described above, a wired/wireless broadcasting distribution apparatus according the present invention receives HD-grade multi-channel ground wave/satellite/cable broadcasting signals, and converts the received broadcasting signals into an IEEE1394 Isochronous packet or converts the IEEE1394 Isochronous packet into a UWB wireless signal, and transmits the IEEE1394 Isochronous packet or the UWB wireless signal to a home client, thereby making it possible to distribute HD-grade multi-channel wired/wireless broadcasting signals requiring a transmission bandwidth of hundreds Mbps to home clients irrespective of place.

Specifically, for wired distribution of a broadcasting signal, the wired/wireless broadcasting distribution apparatus can be directly connected to a digital TV having an IEEE1394 matching function by using an IEEE1394 packet. For wireless distribution of a broadcasting signal, the wired/wireless broadcasting distribution apparatus can be easily connected to a digital TV having an IEEE1394 matching function by means of a simple and small-sized UWB-1394 bridge that converts a UWB broadcasting packet received from the wired/wireless broadcasting distribution apparatus into an IEEE1394 packet.

Also, the wired/wireless broadcasting distribution apparatus can be easily matched with various information appliances located in a home, such as an existing PC, a home gateway server and AV devices by means of a 1394 cable.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A wired/wireless broadcasting distribution apparatus having a home broadcasting distribution function, the apparatus comprising:
a digital broadcasting receiver for selectively receiving HD-grade ground wave/satellite/cable broadcasting signals;
a signal converter for converting MPEG TS (Transport Stream) broadcasting data received from the digital broadcasting receiver into an IEEE1394 Isochronous packet;
a wireless transceiver for matching the IEEE1394 Isochronous packet received from the signal converter and converting the IEEE1394 Isochronous packet into a UWB wireless signal and transmitting the UWB wireless signal to a home wireless network; and
a controller for controlling the digital broadcasting receivers, the signal converter and the wireless transceiver and managing a status of a channel which is being received.

2. The apparatus of claim 1, wherein the signal converter comprises:
a TS matching unit for matching SD/HD grade broadcasting data received from the digital broadcasting receiver;
a 1394 ISO data generator for converting broadcasting data received from the TS matching unit into an IEEE1394 Isochronous packet;
a 1394 data combiner for combining or dividing the IEEE1394 Isochronous packet and a control packet which is transmitted to and received from a home;
a 1394 ASYNC data I/O port for transmitting the control packet to the controller and receiving the control packet from the controller; and
a PHY unit for transmitting an IEEE1394 packet combined by the 1394 data combiner to a home IEEE1394 network or the wireless transceiver.

3. The apparatus of claim 1, wherein the wireless transceiver comprises:
a 1394 matching unit for receiving an IEEE1394 packet transmitted from the signal converter;
a PAL unit for matching the IEEE1394 packet with UWB MAC; and
a UWB MAC/PHY unit for converting the IEEE1394 packet into a UWB wireless packet and transmitting the UWB wireless packet to a home UWB wireless network.

4. A method for generating a broadcasting channel by a wired/wireless broadcasting distribution apparatus having a home broadcasting distribution function, the method comprising the steps of:
(a) if a broadcasting channel reception request signal is received from a home broadcasting reception client, determining whether a broadcasting channel reception request signal is received through a wired IEEE1394 network or through a UWB wireless channel;
(b) if the broadcasting channel reception request signal is received through a wired IEEE1394 network, transmitting a IEEE1394 ID and broadcasting channel information to a signal converter;
(c) after determining at the signal converter whether an additional bandwidth can be currently assigned to the wired IEEE1394 network, if an addition bandwidth can be currently assigned to the wired IEEE1394 network, transmitting a reception channel list update request message to a channel status management unit;
(d) upon receiving the reception channel list update request message at the channel status management unit, determining whether a currently received channel is a new channel;
(e) if the currently received channel is a new channel, registering new channel information in a reception channel list, activating a TS input port of a signal conversion management unit 142 and transmitting a IEEE1394 ID of a reception request client to a 1394 ISO data generator;
(f) selecting a reception tuner at a broadcasting reception management unit according to broadcasting channel information requested by the client and then receiving a broadcasting signal by controlling the selected tuner; and
(g) converting at the signal converter MPEG TS broadcasting data received from the digital broadcasting receiver into a IEEE1394 Isochronous packet, and according to types of the client requesting reception of a broadcasting channel, transmitting the 1394 Isochronous packet to the wired IEEE1394 network or converting the 1394 Isochronous packet into a UWB packet and then transmitting the UWB packet to the home.

5. The method of claim 4, further comprising the steps of:
(h) if the currently received channel is an already serviced channel as a result of the determination in the step (d), requesting the channel status management unit requests a signal conversion management unit, which is processing broadcasting data about the requested channel, to copy a packet corresponding to a IEEE1394 channel;
(i) if the signal conversion management unit transmits a channel copy command to the signal converter, copying broadcasting data at the signal converter; and
(j) transmitting a copied IEEE1394 packet through a wired IEEE1394 network to a client, or after converting the copied IEEE1394 packet into a UWB packet, transmitting the UWB packet through a UWB wireless network to a client.

6. The method of claim 4, wherein if an additional bandwidth cannot be currently assigned to the wired IEEE1394 network in the step (c), the wired/wireless broadcasting distribution apparatus notifies a broadcasting reception client of failure in reception of a IEEE1394 channel.

7. The method of claim 4, further comprising the steps of:
(k) if the channel reception request signal in the step (a) is received through a UWB wireless network, transmitting a UWB ID and broadcasting channel information to the wireless transceiver;
(l) after determining at the wireless transceiver whether an additional bandwidth can be currently assigned to a UWB wireless network, if an additional bandwidth can be currently assigned to a UWB wireless network, transmitting a reception channel list update request message to a channel status management unit;
(m) upon receiving the reception channel list update request message at the channel status management unit, determining whether a currently received channel is a new channel; and
(n) if the currently received channel is a new channel, performing the steps (e) through (g).

8. The method of claim 7, further comprising the step of (o) if a currently received channel is an already serviced channel, performing the steps (h) through (j).

9. The method of claim 7, wherein if an additional bandwidth cannot be currently assigned to the UWB wireless network in the step (l), the wired/wireless broadcasting distribution apparatus notifies a broadcasting reception client of failure in reception of a UWB channel.

10. A method for terminating a broadcasting channel by a wired/wireless broadcasting distribution apparatus having a home broadcasting distribution function, the method comprising the steps of:
(p) if a broadcasting channel termination request signal is received from a home broadcasting reception client and if the channel requested to be terminated corresponds to a wired IEEE1394 network, transmitting the broadcasting channel termination request signal to a signal converter, and if the channel requested to be terminated corresponds to a UWB wireless network, transmitting the broadcasting channel termination request signal through the wireless transceiver to the signal converter 110;
(q) if the signal converter transmits the broadcasting channel termination request signal to a channel status management unit, searching a reception channel list at the channel status management unit and then determining whether a channel requested to be terminated is being transmitted to another client;
(r) if the channel requested to be terminated is not being transmitted to another client, deleting the channel from a reception channel list at the channel status management unit and then requesting a signal conversion management unit to deactivate its TS input port and simultaneously transmitting, to a broadcasting reception management unit, information on a tuner which is receiving a channel which is to be terminated; and
(s) deactivating a corresponding tuner by controlling the digital broadcasting receiver at the broadcasting reception management unit and deleting a IEEE1394 ID or a UWB channel of a client having requested termination of a channel.

11. The method of claim 10, further comprising the step of (t) if the channel requested to be terminated is being transmitted to another client, requesting the signal converter to terminate a IEEE1394 channel and then deleting a IEEE1394 ID of the client having requested termination of a channel, and if the client having requested termination of a channel corresponds to a UWB wireless network, requesting the wireless transceiver 130 to terminate a UWB channel and then deleting a UWB wireless channel.
